(19) United States
(12) Patent Application Publication
(10) Pub. No.: US 2007/0091270 A1
(43) Pub. Date: Apr. 26, 2007

(54) PROJECTOR

(75) Inventor: Koichi AKIYAMA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/532,004

(22) Filed: Sep. 14, 2006

(30) Foreign Application Priority Data
Oct. 18, 2005 (JP) 2005-302789

(51) Int. Cl. G03B 21/26

(52) U.S. Cl. 353/30

(57) ABSTRACT

A projector comprises: an illumination device, a first lens array having a plurality of first small lenses arrayed in a matrix, a second lens array having a plurality of second small lenses corresponding to the plurality of first small lenses are arrayed in a matrix in a plane perpendicular to the illumination optical axis, and a superimposing lens; an electric-optic modulator; and a projection optical system The plurality of second small lenses are arrayed in a matrix and decentered for each row or for each column. A thickness of the individual second small lenses is adjusted in order to reduce an unevenness in a boundary between each second small lens. A curvature of the individual second small lenses is set in such a way that images of the corresponding first small lenses are formed in the same location in the vicinity of an image forming region of the electro-optic modulator.

### BACKGROUND

1. Technical Field

The present invention relates to a projector.

2. Related Art

A projector has heretofore been known which includes a first lens array, a second lens array and a superimposing lens as a light integrator optical system, wherein both first small lenses of the first lens array and second small lenses of the second lens array are decentered (at least one of the first small lenses of the first lens array is decentered outwardly of an illumination optical axis, and the second small lenses of the second lens array are decentered substantially parallel or inward with respect to the illumination optical axis) (for example, refer to JP-A-10-115870).

According to the existing projector, a light comparatively inhomogeneous in in-plane light intensity distribution, emitted from a light source device, is converted into a light comparatively homogeneous in in-plane light intensity distribution by the action of the first lens array, second lens array and superimposing lens. Therefore, an image forming region of an electro-optic modulator, which is an object to be illuminated, can be irradiated by such a light comparatively homogeneous in in-plane light intensity distribution.

Also, according to the existing projector, at least one of the first small lenses of the first lens array is decentered outwardly of the illumination optical axis. Therefore, it is possible to increase the size of each second small lens of the second lens array; making it possible to increase a proportion of the light passed through the first lens array incident on each second small lens. As a result, it is possible to improve a projector's light use efficiency.

However, in the existing projector, as unevenness exists in a boundary between each decentered second small lens, in a case of manufacturing the second lens array, for example, by pressing, a die releasing is deteriorated. As a result, it is likely to cause an edge roll off (in which a lens peripheral edge is not formed to have a specified angle but becomes rounded) and a chip in an uneven portion, resulting in a problem that it is not easy to manufacture a lens array of a shape desirable for the second lens array.

An advantage of some aspects of the invention is to provide a projector for which it is possible to manufacture a lens array of a shape desirable for a second lens array.

A projector according to an aspect of the invention comprises: an illumination device; an electric-optic modulator which modulates the illumination light fluxes from the illumination device in accordance with image information; and a projection optical system which projects the light modulated by the electro-optic modulator. The illumination device includes: a light source device which emits an illumination light flux to an illuminated region side; a first lens array in which a plurality of first small lenses that divides the illumination light flux emitted from the light source device into a plurality of partial light fluxes is arrayed in a matrix in a plane perpendicular to an illumination optical axis; a second lens array in which a plurality of second small lenses corresponding to the plurality of first small lenses is arrayed in a matrix in a plane perpendicular to the illumination optical axis; and a superimposing lens that superimposes the partial light fluxes emitted from the plurality of second small lenses, one on another, in an illuminated region. The plurality of second small lenses are decentered for each row or for each column, and a thickness of the individual second small lenses is adjusted in order to reduce an unevenness in a boundary between the respective second small lenses. In this case, a curvature of the individual second small lenses is set in such a way that images of the corresponding first small lenses are formed in the same location in the vicinity of an image forming region of the electro-optic modulator.

For this reason, according to the projector of the aspect of the invention, the thickness of each second small lens is adjusted in order to reduce unevenness in a boundary between the respective second small lenses. Therefore, it is possible to suppress a deterioration in die releasing in a case of manufacturing the second lens array by pressing. As a result, it is possible to manufacture a lens array of a shape desirable for the second lens array.

The “thickness of the small lenses” refers to a maximum distance between a light incidence surface and a light emergence surface of each small lens.

Meanwhile, to manufacture the second lens array, in a case in which the plurality of second small lenses is not decentered, of course, it is easy to reduce unevenness on the whole surface of the second lens array. However, in a case in which the plurality of second small lenses is decentered both for each row and for each column, it is not easy to reduce unevenness on the whole surface of the second lens array. Therefore, it is not easy to manufacture a lens array of a shape desirable for the second lens array.

In contrast, according to the projector of the aspect of the invention, the plurality of second small lenses is decentered for each row or for each column. Therefore, it is possible to reduce unevenness on the whole surface of the second lens array, making it possible to manufacture a lens array of a shape desirable for the second lens array.

For this reason, the projector according to the aspect of the invention provides a projector for which it is possible to manufacture a lens array of a shape desirable for the second lens array.

Meanwhile, in such a projector in which the thickness of each second small lens is adjusted, the distances between the convex vertices of the corresponding first and second small lenses are different depending on the respective first and second small lenses. For this reason, images of the first small lenses are made different in image location and magnification for each of the individual partial light fluxes emitted from the plurality of second small lenses of the second lens array. As a result, use efficiency and uniformity of a light irradiating the image forming region of the electro-optic modulator is reduced, making it difficult to obtain a bright and uniform in-plane display characteristic on a projection screen

In contrast, according to the projector of the aspect of the invention, the curvature of the individual second small lenses is set in such a way that the images of the corresponding first small lenses are formed in the same location in the vicinity of the image forming region of the electro-optic modulator. Therefore, even in a case of using the second lens array in which, as described heretofore, the plurality of second small lenses are decentered for each row or for each coleman, and the thickness of each second small lens is adjusted in order to reduce an unevenness in the boundary between the respective second small lenses, it is possible to make the images of the first small lenses substantially identical in image location and magnification for each of the individual partial light fluxes emitted from the plurality of second small lenses of the second lens array. As a result, it is also possible to obtain an advantageous effect that a reduction in use efficiency and uniformity of a light irradiating the image forming region of the electro-optic modulator can be suppressed, making it possible to obtain a bright and uniform in-plane display characteristic on the projection screen.

In a projector according to another aspect of the invention, preferably, the curvature of the individual second small lenses is set individually for each small lens.

With such a configuration, it is easy to make the images of the first small lenses substantially identical in image location and magnification for each of the individual partial light fluxes emitted from the plurality of second small lenses of the second lens array. Therefore, it is easy to suppress a reduction in use efficiency and uniformity of a light irradiating the image forming region of the electro-optic modulator, making it possible to obtain a brighter and more uniform in-plane display characteristic on the projection screen.

In a projector according to a further aspect of the invention, preferably, the curvature of the individual second small lenses is set in such a way that the second small lenses disposed on the central side of the second lens array are larger in curvature radius than the second small lenses disposed on the outer peripheral side of the second lens array.

In the projector in which the thickness of each second small lens is adjusted as described heretofore, the distances between the convex vertices of the corresponding first and second small lenses are different depending on the respective first and second small lenses.

For this reason, when the images of the first small lenses disposed on the outer peripheral side of the first lens array are formed in the vicinity of the image forming region, the images of the first small lenses disposed on the central side of the first lens array are formed in a position closer to the second lens array side than the position of the image forming region. Contrarily, when the images of the first small lenses disposed on the central side of the first lens array are formed in the vicinity of the image forming region, the images of the first small lenses disposed on the outer peripheral side of the first lens array are formed in a position closer to the projection screen side than the position of the image forming region.

In this way, the images of the first small lenses are made different in image location and magnification for each of the individual partial light fluxes emitted from the plurality of second small lenses of the second lens array. As a result, use efficiency and uniformity of the light irradiating the image forming region of the electro-optic modulator is reduced, making it difficult to obtain a bright and uniform in-plane display characteristic on the projection screen.

In contrast, according to the projector of the aspect of the invention, the curvature of each second small lens is set in such a way that the second small lenses disposed on the central side of the second lens array are larger in curvature radius than the second small lenses disposed on the outer peripheral side of the second lens array. Therefore, when the images of the first small lenses disposed on the outer peripheral side of the first lens array are formed in the vicinity of the image forming region, the images of the first small lenses disposed on the central side of the first lens array can be formed in the vicinity of the image forming region. Contrarily, when the images of the first small lenses disposed on the central side of the first lens array are formed in the vicinity of the image forming region, the images of the first small lenses disposed on the outer peripheral side of the first lens array can be formed in the vicinity of the image forming region. That is, it is possible to make the images of the first small lenses substantially identical in image location and magnification for each of the individual partial light fluxes emitted from the plurality of second small lenses of the second lens array. As a result, a reduction in use efficiency and uniformity of the light irradiating the image forming region of the electro-optic modulator can be suppressed, making it possible to obtain a bright and uniform in-plane display characteristic on the projection screen.

As used herein, the “small lenses disposed on the outer peripheral side of the lens array” refers to those of the small lenses arrayed in a matrix disposed in a position far from the illumination optical axis. Also, the “small lenses disposed on the central side of the lens array” refers to those of the small lenses arrayed in a matrix disposed in a position closer to the illumination optical axis.

A projector according to a still further aspect of the invention further comprises a polarization conversion element provided between the second lens array and the superimposing lens. The polarization conversion includes a polarization separating layer, a reflecting layer and a phase plate. The polarization separating layer transmits illumination light fluxes related to one linear polarization component of polarization directions included in the individual partial light fluxes from the second lens array, and reflects illumination light fluxes related to the other linear polarization component. The reflecting layer reflects the illumination light fluxes related to the other linear polarization component, reflected off the polarization separating layer, in a direction substantially parallel to the illumination optical axis. The phase plate is disposed either in a portion through which the illumination light fluxes related to the one linear polarization component pass, transmitted through the polarization separating layer, or in a portion through which the illumination fluxes related to the other linear polarization component pass, reflected off the reflecting layer. The projector further comprises a light shielding member disposed on the light incidence surface side of the polarization conversion element. The light shielding member includes a light shielding portion disposed in a position corresponding to the reflecting layer and a light transmissive portion disposed in a position corresponding A the polarization separating layer. In this case, preferably the plurality of second small lenses are decentered in such a way that the individual partial light fluxes from the first lens array are made incident on the light transmissive portion.

With such a configuration, each partial light flux from the second lens array is efficiently made incident on the polarization separating layer of the polarization conversion element. Therefore, it is possible to Improve a use efficiency of the light irradiating the image forming region, making it possible to obtain a brighter in-plane display characteristic on the projection screen.

Also, illumination light fluxes, not uniform in polarization direction, emitted from the light source device can be converted into substantially one-type linear polarization lights of uniform direction by the aforementioned action of the polarization conversion element. Therefore, the projector is suitable for a case in which an electro-optic modulator of a type using a polarization light, such as a liquid crystal device having a liquid crystal panel, is used as the electric-optic modulator.

In a projector according to a still further aspect of the invention, preferably, in a case that the light source device is a light source device which emits a divergent light having the illumination optical axis as its central axis, the plurality of second small lenses are decentered in such a way that a principal ray of each partial light flux becomes substantially parallel to the illumination optical axis.

With such a configuration, it is possible to increase a proportion of the light passed through the first lens array incident on each second small lens, making it possible to improve a projector's light use efficiency.

In a projector according to a still further aspect of the invention, preferably, in a case that the light source device is a light source device which emits a light substantially parallel to the illumination optical axis, the plurality of first small lenses are decentered in such a way that the light from the light source device becomes a divergent light having the illumination optical axis as its central axis, and the plurality of second small lenses are decentered in such a way that the principal ray of each partial light flux from the first lens array becomes a light substantially parallel to the illumination optical axis.

With such a configuration, it is possible to increase a proportion of the light passed through the first lens array incident on each second small lens, making it possible to improve a projector's light use efficiency.

In this case, preferably, the plurality of first small lenses are decentered for each row or for each column, and the thickness of each first small lens is adjusted in order to reduce an unevenness in the boundary between each first small lens.

With such a configuration, the thickness of each first small lens is adjusted in order to reduce unevenness in the boundary between the respective first small lenses. Therefore, it is possible to suppress a deterioration in die releasing in a case of manufacturing the first lens array by pressing. As a result, it is possible to manufacture a lens array of a shape desirable for the first lens array.

Meanwhile, to manufacture the first lens array, in a case that the plurality of first small lenses are not decentered, of course, it is easy to reduce an unevenness on the whole surface of the first lens array. However, in a case that the plurality of first small lenses is decentered both for each row and for each column, it is not easy to reduce unevenness on the whole surface of the first lens array. Therefore, it is not easy to manufacture a lens array of a shape desirable for the first lens array.

In contrast, according to the projector of the aspect of the invention, the plurality of first small lenses is decentered for each row or for each column. Therefore, it is possible to reduce unevenness on the whole surface of the first lens array, making it possible to manufacture a lens array of a shape desirable for the first lens array.

In a projector according to a still further aspect of the invention, preferably, the first lens array and the second lens array are integrally molded.

With such a configuration, illumination light fluxes emitted from the first lens array are made incident on the second lens array without passing through any air space, thus preventing an occurrence of a light reflection off a first lens array light emergence surface and a second lens array light incidence surface and so on. For this reason, it is possible to suppress a light quantity loss due to such an undesirable reflection etc. Also, to assemble the apparatus, there is no need to align the first lens array and the second lens array, and it is possible to suppress a deterioration in position accuracy of the first lens array and the second lens array after assembling the apparatus.

In a projector according to a still further aspect of the invention, preferably, the first lens array and the second lens array are separate from each other.

With such a configuration, the first lens array and the second lens array can be press molded as separate members, thus making it easy to manufacture the first lens array and the second lens array.

The projector, in which the first lens array and the second lens array are separate from each other, further comprises a light transmissive member, disposed between the first lens array and the second lens array, for the purpose of guiding the light from the first lens array to the second lens array. In this case, preferably, the first lens array and the second lens array are bonded via the light transmissive member.

With such a configuration, illumination light fluxes emitted from the first lens array are made incident on the second lens array without passing through any air space, thus making it possible to suppress a light reflection off the first lens array light emergence surface and the second lens array light incidence surface and so on. For this reason, it is possible to reduce a light quantity loss due to such an undesirable reflection etc. Also, to assemble the apparatus, the first lens array and the second lens array are aligned and thereafter bonded to the light transmissive member, whereby it is only necessary to adjust the relative positions of a lens array unit, configured of these first lens array, second lens array and light transmissive member, and the other optical elements, so that an alignment of each optical element can be easily carried out.

In a case of the projector, in which the first lens array and the second lens array are bonded via the light transmissive member as described heretofore, preferably, the light transmissive member has a refractive index substantially equal to that of the first lens array and the second lens array.

Furthermore, preferably, an adhesive for bonding the first lens array, the light transmissive member and the second lens array also has a refractive index substantially equal to that of the first lens array and the second lens array.

With such a configuration, it is possible to suppress a light reflection off an interface between the first lens array and the light transmissive member and an interface between the light transmissive member and the second lens array and so on. Therefore, it is possible to further reduce a light quantity loss due to such an undesirable reflection etc.

In the case of the projector, in which the first lens array and the second lens array are bonded via the light transmissive member as described heretofore, preferably, the light transmissive member has a linear expansion coefficient substantially equal to that of the first lens array and the second lens array.

With such a configuration, it is possible to suppress an occurrence of thermal stress involved in a temperature change due to a use of the projector. Therefore, it is possible to suppress damage in a connection between the first lens array and the light transmissive member and in a connection between the light transmissive member and the second lens array.

According to the above, in the case of the projector, in which the first lens array and the second lens array are bonded via the light transmissive member as described heretofore, more preferably, the light transmissive member is made of a base material identical to that of the first lens array and the second lens array.

Preferably, a projector according to a still further aspect of the invention, as well as comprising, as the electric-optic modulator, a plurality of electro-optic modulators which modulate a respective plurality of color lights in accordance with image information, further comprises: a color separation light guide optical system, which separates the illumination light flux from the illumination device into a plurality of color lights and guides them to the respective plurality of electro-optic modulators; and a color combination optical system, which combines the color lights modulated by the respective plurality of electro-optic modulators.

With such a configuration, the projector for which it is possible to manufacture a lens array of a shape desirable for the second lens array can be a (for example, 3-LCD) full color projector having an excellent image quality.

### BRIEF DESCRIPTION OF THE DRAWINGS

The invention will be described with reference to the accompanying drawings, wherein like numbers reference like elements.

FIGS. 1A to 1C are views shown for illustrating a projector 1000 according to embodiment 1.

FIGS. 2A and 2B are views shown for illustrating a polarization conversion element 140 and a light shielding member 160.

FIGS. 3A to 3C are conceptual diagrams shown for illustrating advantageous effects of the projector 1000 according to embodiment 1.

FIGS. 4A to 4C are views shown for illustrating a projector 1002 according to embodiment 2.

FIGS. 5A to 5C are views shown for illustrating a projector 1004 according to embodiment 3.

FIGS. 6A to 6C are views shown for illustrating a projector 1006 according to embodiment 4.

### DESCRIPTION OF EXEMPLARY EMBODIMENTS

A projector of aspects of the invention will hereafter be described with reference to embodiments shown in the drawings.

### Embodiment 1

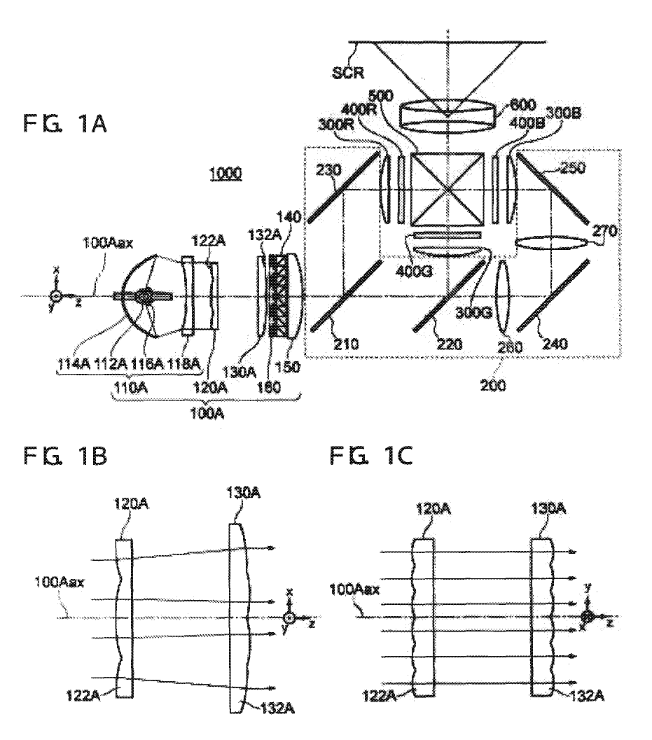

FIGS. 1A to 1C are views shown for illustrating a projector 1000 according to embodiment 1. FIG. 1A is a view showing an optical system of the projector 1000, FIG. 1B is a top view of a main portion of the projector 1000, and FIG. 1C is a side view of the main portion of the projector 1000.

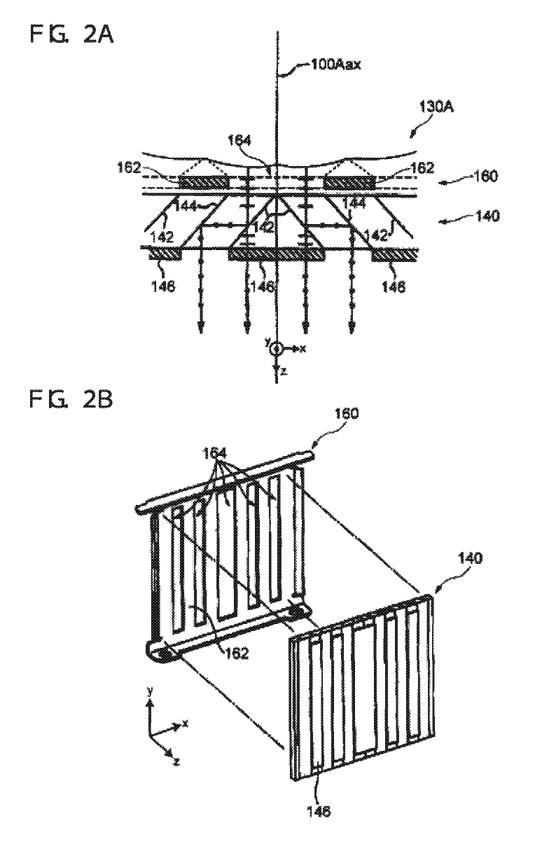

FIGS. 2A and 2E are views shown for illustrating a polarization conversion element 140 and a light shielding member 160. FIG. 2A is a top view of a portion of the polarization conversion element 140 and the light shielding member 160, and FIG. 2B is a perspective view of the polarization conversion element 140 and the light shielding member 160.

In the following description, three mutually perpendicular directions are a z axis direction (illumination optical axis 100Aax direction in FIG. 1A), an x axis direction (direction parallel to the plane of FIG. 1A and perpendicular to the z axis direction) and a y axis direction (direction perpendicular to the plane of FIG. 1A and perpendicular to the z axis direction).

As shown in FIG. 1A, the projector 1000 of embodiment 1 includes an illumination device 100A which emits illumination light fluxes, a color separation light guide optical system 200 which separates the light from the illumination device 100A into three color lights and guides them to an illuminated region, three liquid crystal devices 400R, 400G and 400B acting as electro-optic modulators which modulate the three respective color lights, separated by the color separation light guide optical system 200, in accordance with image information, a cross dichroic prism 500 acting as a color combination optical system which combines the color lights modulated by the liquid crystal devices 400R, 400G and 400B, and a projection optical system 600 which projects the light combined by the cross dichroic prism 500 onto a projection surface such as a screen SCR.

The illumination device 100A includes a light source device 110A which emits an illumination light flux to the illuminated region side, a first lens array 120A which includes a plurality of first small lenses 122A for dividing the illumination light flux emitted from the light source device 110A into a plurality of partial light fluxes, a second lens array 130A which includes a plurality of second small lenses 132A corresponding to the plurality of first small lenses 122A, the polarization conversion element 140 which makes the individual partial light fluxes, divided by the first lens array 120A, uniform in polarization direction and emits them as substantially one-type linear polarization lights of uniform polarization direction, and a superimposing lens 150 for superimposing the partial light fluxes emitted from the polarization conversion element 140, one on another, in the illuminated region.

The light source device 110A includes an ellipsoidal reflector 114A, a luminous tube 112A having a luminescent center in the vicinity of a first focal point of the ellipsoidal reflector 114A, an auxiliary mirror 116A acting as a reflector which, being provided on the luminous tube 112A, reflects a light, emitted from the luminous tube 112A to the illuminated region side, toward the ellipsoidal reflector 114A, and a concave lens 118A which converts a converging light reflected off the ellipsoidal reflector 114A into a substantially parallel light and emits it toward the first lens array 120A. The light source device 110A emits a luminous flux having the illumination optical axis 100Aax as its central axis.

The luminous tube 112A includes a tube portion and a pair of sealing portions extending to both sides of the tube portion.

The ellipsoidal reflector 114A includes a tubular neck-like portion, which is inserted through and fixed to one of the sealing portions of the luminous tube 112A, and a reflecting concave surface which reflects the light, emitted from the luminous tube 112A, toward the position of a second focal point.

The auxiliary mirror 116A, being provided across the tube portion of the luminous tube 112A from the ellipsoidal reflector 114A, causes the light emitted from the luminous tube 112A, which is not directed to the ellipsoidal reflector 114A, to return to the luminous tube 112A and enter the ellipsoidal reflector 114A.

The concave lens 118A, disposed on the illuminated region side of the ellipsoidal reflector 114A, is configured in such a way as to emit the light from the ellipsoidal reflector 114A toward the first lens array 120A.

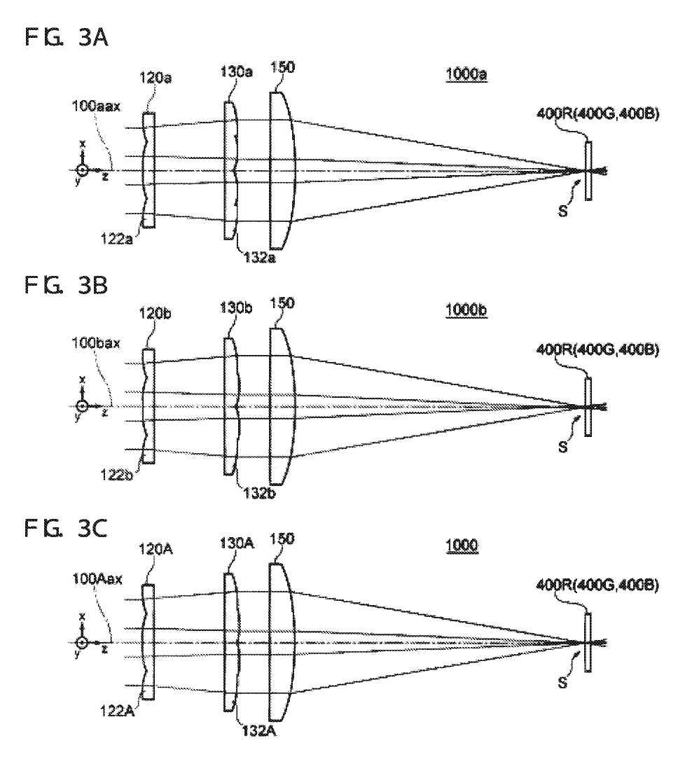

The first lens array 120A, having a function of serving as a luminous flux division optical element which divides the light from the concave lens 118A into a plurality of partial light fluxes, is configured to include the plurality of first small lenses 122A which are arrayed in a matrix in a plane perpendicular to the illumination optical axis 100Aax. Although an illustrative description is omitted, the outer shape of the first small lenses 122A is similar to that of an image forming region S (refer to FIG. 3C to be described hereafter) of the liquid crystal device 400R, 400G, 400B.

The second lens array 130A, which is an optical element which collects the plurality of partial light fluxes divided by the first lens array 120A, is configured, similarly to the first lens array 120A, to include the plurality of second small lenses 132A which are arrayed in a matrix in a plane perpendicular to the illumination optical axis 100Aax.

The first lens array 120A and the second lens array 130A will be described hereafter in detail.

The polarization conversion element 140 is a polarization conversion element which makes the individual partial light fluxes, divided by the first lens array 120A, uniform in polarization direction and emits them as substantially one-type linear polarization lights of uniform polarization direction.

As shown in FIG. 2A, the polarization conversion element 140 includes a polarization separating layer 142 which transmits illumination light fluxes related to one linear polarization component of the polarization directions included in the individual partial light fluxes from the second lens array 130A, and which reflects illumination light fluxes related to the other linear polarization component, a reflecting layer 144 which reflects the illumination light fluxes related to the other linear polarization component, reflected off the polarization separating layer 142, in a direction substantially parallel to the illumination optical axis, and a phase plate 146 which is disposed in a portion through which the illumination light fluxes related to the one linear polarization component pass, transmitted through the polarization separating layer 142.

Also, as shown in FIGS. 1A to 2B, the light shielding member 160 is disposed on the light incidence plane side of the polarization conversion element 140. The light shielding member 160 includes a light shielding portion 162 disposed in a position corresponding to the reflecting layer 144 of the polarization conversion element 140, and a light transmissive portion 164 disposed in a position corresponding to the polarization separating layer 142 of the polarization conversion element 140.

The superimposing lens 150 is an optical element for collecting the plurality of partial light fluxes passed through the first lens array 120A, the second lens array 130A and the polarization conversion element 140, and superimposing them, one on another, in the image forming region S of the liquid crystal device 400R, 400G, 400B. Although the superimposing lens 150 shown in FIG. 1A is configured of a single lens, it may also be configured of a compound lens formed by combining a plurality of lenses.

The color separation light guide optical system 200 includes a first dichroic mirror 210, a second dichroic mirror 220, reflecting mirrors 230, 240 and 250, an incidence side lens 260 and a relay lens 270. The color separation light guide optical system 200 has a function of separating the illumination light fluxes emitted from the superimposing lens 150 into three color lights, a red light, a green light and a blue light, and guiding the individual color lights to the three respective liquid crystal devices 400R, 400G and 40DB which are to be illuminated.

The first dichroic mirror 210 and the second dichroic mirror 220 are optical elements each formed with a wavelength selective film which reflects luminous fluxes of a prescribed wavelength range off its substrate and transmits luminous fluxes of the other wavelength ranges. The first dichroic mirror 210 is a mirror which reflects a red light component and transmits the other color components. The second dichroic mirror 220 is a mirror which reflects a green light component and transmits a blue light component.

The red light component reflected off the first dichroic mirror 210 is refracted by the reflecting mirror 230 and made incident on the image forming region S of the red light liquid crystal device 400R via a collective lens 300R.

The collective lens 300R is provided in order to convert the individual partial light fluxes from the superimposing lens 150 into luminous fluxes substantially parallel to their respective principal rays. Collective lenses 300G and 300B, which are located in an optical path upstream of the other liquid crystal devices 400G and 400B, also have the same configuration as the collective lens 300R.

Of the green and blue light components passed through the first dichroic mirror 210, the green light component is reflected by the second dichroic mirror 220, passed through the collective lens 300G, and then made incident on the image forming region S of the green light liquid crystal device 400G. However, the blue light component 1s transmitted through the second dichroic mirror 220, passed through the incidence side lens 260, the incidence side reflecting mirror 240, the relay lens 270, the emergence side reflecting mirror 250 and the collective lens 300B, and then made incident on the image forming region S of the blue light liquid crystal device 400B. The incidence side lens 260, the relay lens 270 and the reflecting mirror 240 and 250 have a function of guiding the blue light component, transmitted through the second dichroic mirror 220, to the liquid crystal device 400B.

The reason that such an incidence side lens 260, relay lens 270 and reflecting mirrors 240 and 250 are provided in the optical path of the blue light is, as the optical path of the blue light is longer in length than that of the other color lights, to prevent a reduction in light use efficiency due to light divergence etc Although the projector 1000 of embodiment 1 has such a configuration owing to the optical path of the blue light being longer in length, a configuration in which the optical path of the red light is made longer in length, and the incidence side lens 260, relay lens 270 and reflecting mirrors 240 and 250 are used in such a lengthened optical path of the red light, can also be considered.

The liquid crystal devices 400R, 400G and 400B form a color image by modulating the illumination light fluxes in accordance with the Image information, and are objects to be illuminated by the light source device 110A. Although not shown, an incidence side polarization plate is interposed between each of the converging lenses 300R, 300G and 300B and each of the liquid crystal devices 400R, 400G and 400B, while an emergence side polarization plate is interposed between each of the liquid crystal devices 400R, 400G and 400B and the cross dichroic prism 500. The incident color lights are optically modulated by the incidence side polarization plates, the liquid crystal devices 400R, 400G and 400B, and the emergence side polarization plates, respectively.

The liquid crystal devices 400R, 400G and 400B are each configured by hermetically sealing a liquid crystal, which is an electro-optic material, in a pair of transparent glass substrates. For example, a polarization direction of the one-type linear polarization lights emitted from the incidence side polarization plate is modulated, in accordance with given image information, using a polysilicon TFT as a switching element.

The cross dichroic prism 500 acting as the color combination optical system is an optical element which forms a color image by combining optical images modulated for each color light emitted from the emergence side polarization plate. The cross dichroic prism 500 is formed in a substantially square shape in plan view with four right-angle prisms stuck together, wherein dielectric multilayers are formed on substantially X-shaped interfaces formed by sticking the right-angle prisms together. The dielectric multilayer formed on one of the substantially X-shaped interfaces is reflective of the red light, and the dielectric multilayer formed on the other interface is reflective of the blue light. The red light and the blue light are bent by these dielectric multilayers and aligned with the traveling direction of the green light, thereby combining the three color lights

The color image emitted from the cross dichroic prism 500 is enlarged and projected by the projection optical system 600, forming a large screen image on the screen SCR.

The projector 1000 of embodiment 1 is characterized by a configuration of the second lens array. Advantageous effects of the projector 1000 of embodiment 1 will hereafter be described in detail by comparing a configuration of the projector 1000 of embodiment a configuration of a projector 1000a according to a comparative example 1 of embodiment 1, and a configuration of a projector 1000b according to a comparative example 2 of embodiment 1.

FIGS. 3A to 3B are conceptual diagrams shown for illustrating advantageous effects of the projector 1000 according to the embodiment 1. FIG. 3A is a conceptual diagram shown for illustrating the projector 1000a according to comparative example 1 of embodiment 1. FIG. 3B is a conceptual diagram shown for illustrating the projector 1000b according to comparative example 2 of embodiment 1. FIG. 3C is a conceptual diagram shown for illustrating the projector 1000 according to embodiment 1.

In FIGS. 3A to 3C, in order to facilitate the description, of the optical systems of the projector, only a first lens array, a second lens array, a superimposing lens and a liquid crystal device (image forming region S) are illustrated, and the other optical systems (a polarization conversion element etc.) are omitted from the illustration.

Although the projector 1000a of comparative example 1 basically has a configuration similar to that of the projector 1000 of embodiment 1, the second lens array of the projector 1000a is different in configuration from that of the projector 1000 of embodiment 1. That is, in the projector 1000a of comparative example 1, as shown in FIG. 3A, unevenness exists in a boundary between the respective second small lenses 132a of a second lens array 130a. The projector 1000a of comparative example 1 has the same configuration as the projector 1000 of embodiment 1 with the exception of the configuration of the second lens array.

In the projector 1000a of comparative example 1, as shown in FIG. 3A, first small lenses 122a disposed on the outer peripheral side of a first lens array 120a are decentered in such a way as to emit the incident illumination light fluxes outward with respect to an illumination optical axis 100aax, while first small lenses 122a disposed on the central side of the first lens array 120a are decentered in such a way as to emit the incident illumination light fluxes inward with respect to the illumination optical axis 100aax. The individual second small lenses 132a of the second lens array 130a are decentered in such a way as to emit the incident illumination light fluxes substantially parallel to the illumination optical axis 100aax. Also, both the first small lenses 122a and the second small lenses 132a are decentered for each column.

In the projector 1000a of comparative example 1, as each corresponding first and second small lens 122a, 132a have the same distance between their convex vertices, images of the individual first small lenses 122a are formed in the same location in the vicinity of the image forming region S.

However, in the projector 1000a of comparative example 1, as unevenness exists in the boundary between the respective decentered second small lenses 132a, in a case of manufacturing the second lens array 130a, for example, by pressing, a die releasing is deteriorated. As a result, it is likely to cause an edge roll off (in which a lens peripheral edge is not formed to have a specified angle but becomes rounded) and a chip in an uneven portion, resulting in a problem wherein it is not easy to manufacture a lens array of a shape desirable for the second lens array.

As a projector capable of solving such a problem of the projector 1000a of comparative example 1, there is the projector 1000b of comparative example 2.

Although the projector 1000b of comparative example 2 basically has a configuration similar to the projector 1000a of comparative example 1, the second lens array of the projector 1000b is different in configuration from that of the projector 1000a of comparative example 2. That is, in the projector 1000b of comparative example 2, as shown in FIG. 3B, a second lens array 130b has the thickness of each second small lens 132b adjusted in order to reduce an unevenness in the boundary between the respective second small lenses 132b. The projector 1000b of comparative example 2 has the same configuration as the projector 1000a of comparative example 1 with the exception of the configuration of the second lens array.

According to the projector 1000b of comparative example 2, the thickness of each second small lens 132b is adjusted in order to reduce unevenness in the boundary between the respective second small lenses 132b. Therefore, it is possible to suppress a deterioration in die releasing in a case of manufacturing the second lens array 130b by pressing. As a result, it is possible to manufacture a lens array of a shape desirable for the second lens array.

However, the projector 1000b of comparative example 2 has a problem shown below. That is, according to the projector 1000b of comparative example 2, the distances between the convex vertices of the corresponding first and second small lenses 122b, 132b are different depending on the respective first and second small lenses. For this reason, images of the first small lenses 122b are made different in image location and magnification for each of the individual partial light fluxes emitted from a plurality of the second small lenses 132b of the second lens array 130b (refer to FIG. 3B). As a result, use efficiency and uniformity of a light irradiating the image forming region S of the liquid crystal device 400R, 400B, 400B is reduced, making it difficult to obtain a bright and uniform in-plane display characteristic on the screen SCR.

It is the projector 1000 of embodiment 1, which is the invention, that solves both the problem of the projector 1000a of comparative example 1 and the problem of the projector 1000b of comparative example 2, which have been described heretofore.

In the projector 1000 of embodiment 1, as shown in FIG. 3c, the second lens array 130A has a configuration in which the thickness of each second small lens 132A is adjusted in order to reduce unevenness in the boundary between the respective second small lenses 132A.

As shown in FIGS. 1A to 2B and 3C, the individual second small lenses 132A of the second lens array 130A are decentered in such a way as to emit the incident illumination light fluxes by making them substantially parallel to the illumination optical axis 100Aax, and decentered for each column, as well as being decentered in such a way that the individual partial light fluxes from the second lens array 130A are made incident on a light transmissive portion 164 of a light shielding member 160.

As shown in FIG. 3C, the curvature of the individual second small lenses 132A is set individually for each small lens, in such a way that images of the corresponding small lenses 122A are formed in the same location in the vicinity of the image forming region S of the liquid crystal device 400R, 400G, 400B.

As shown in FIG. 30, the distances between the convex vertices of the corresponding first and second small lenses 122A, 132A are different depending on the respective first and second small lenses.

As described heretofore, according to the projector 1000 of embodiment 1, the thickness of each second small lens 132A is adjusted in order to reduce unevenness in the boundary between the respective second small lenses 132A. Therefore, it is possible to suppress a deterioration in die releasing in a case of manufacturing the second lens array 130A by pressing. As a result, it is possible to manufacture a lens array of a shape desirable for the second lens array.

Also, according to the projector 1000 of embodiment 1, as the plurality of second small lenses 132A are decentered for each column, it is possible to reduce an unevenness on the whole surface of the second lens array 130A, thus making it possible to manufacture a lens array of a shape desirable for the second lens array.

Furthermore, according to the projector 1000 of embodiment 1, the curvature of the individual second small lenses 132A is set in such a way that the images of the corresponding small lenses 122A are formed in the same location in the vicinity of the image forming region S of the liquid crystal device 400R, 400G, 400B. Therefore, even in a case of using the second lens array 130A in which, as described heretofore, the distances between the convex vertices of the corresponding first and second small lenses 122A, 132A are different depending on the respective first and second small lenses, furthermore, the plurality of second small lenses 132A are decentered for each column, and the thickness of each second small lens 132A is adjusted in order to reduce an unevenness in the boundary between each second small lens 132A, it is possible to make the images of the first small lenses 122A substantially identical in image location and magnification for each of the individual partial light fluxes emitted from the plurality of second small lenses 132A of the second lens array 130A. As a result, a reduction in use efficiency and uniformity of a light irradiating the image forming region S of the liquid crystal device 400R, 400B, 400B can be suppressed, making it possible to obtain a bright and uniform in-plane display characteristic on the screen SCR.

According to the above, the projector 1000 of embodiment 1 provides a projector for which it is possible to manufacture a lens array of a shape desirable for the second lens array. Also, it provides a projector capable of obtaining a bright and uniform in-plane display characteristic on the screen SCR.

Also, as the curvature of the individual second small lenses 132A are set individually for each small lens, it is possible to make the images of the first small lenses 122A substantially identical in image location and magnification for each of the individual partial light fluxes emitted from the plurality of second small lenses 132A of the second lens array 130A. As a result, a reduction in use efficiency and uniformity of a light irradiating the image forming region S of the liquid crystal device 400R, 400B, 400B can be suppressed, making it possible to obtain a brighter and more uniform in-plane display characteristic on the screen SCR.

Furthermore, the plurality of second small lenses 132A of the second lens array 130A are decentered in such a way that each partial light flux from the second lens array 130A is made incident on the light transmissive portion 164 of the light shielding member 160. Therefore, each partial light flux from the second lens array 130A is efficiently made incident on the polarization separating layer 142 of the polarization conversion element 140. For this reason, it is possible to improve a use efficiency of the light irradiating the image forming region S, making it possible to obtain a brighter In-plane display characteristic on the screen SCR.

Further still, illumination light fluxes, not uniform in polarization direction, emitted from the light source device 110A can be converted into substantially one-type linear polarization lights of uniform direction by the aforementioned action of the polarization conversion element 140. Therefore, the projector 1000 is suitable for a case in which an electro-optic modulator of a type using a polarization light, such as a liquid crystal device having a liquid crystal panel, is used as the electric-optic modulator.

At this point, advantageous effects of the projector 1000 of embodiment 1 will be described again by comparing the configuration of the projector 1000b of comparative example 2 and the configuration of the projector 1000 of embodiment 1.

In the projector 1000b of comparative example 2, the distances between the convex vertices of the corresponding first and second small lenses 122b, 132b are different depending on the respective first and second small lenses. Therefore, when the images of the first small lenses 122b (small lenses disposed in a position far from the illumination optical axis 10bax) disposed on the outer peripheral side of the first lens array 120b are formed in the vicinity of the image forming region S, the images of the first small lenses 122b (small lenses disposed in a position closer to the illumination optical axis 100bax) disposed on the central side of the first lens array 120b are formed in a position closer to the second lens array 130b than the position of the image forming region S (refer to FIG. 3B).

For this reason, according to the projector 1000b of comparative example 2, the images of the first small lenses 122b are made different in image location and magnification for each of the individual partial light fluxes emitted from the plurality of second small lenses 132b of the second lens array 130b. As a result, use efficiency and uniformity of the light irradiating the image forming region S of the liquid crystal device 400R, 400G, 400B is reduced, making it difficult to obtain a bright and uniform in-plane display characteristic on the screen SCR.

In contrast, according to the projector 1000 of embodiment 1, the curvature of each second small lens 132A is set in such a way that the second small lenses 132A disposed on the central side of the second lens array 130A are larger In curvature radius than the second small lenses 132A disposed on the outer peripheral side of the second lens array 130A. Therefore, when the images of the first small lenses disposed on the outer peripheral side of the first lens array 120A are formed in the vicinity of the image forming region S, the images of the first small lenses 122A disposed on the central side of the first lens array 120A can be formed in the vicinity of the image forming region S (refer to FIG. 3C). That is, even in the event that the distances between the convex vertices of the corresponding first and second small lenses 122A, 132A are different depending on the respective first and second small lenses, it is possible to make the images of the first small lenses 122A substantially identical in image location and magnification for each of the individual partial light fluxes emitted from the plurality of second small lenses 132A of the second lens array 130A. As a result, a reduction in use efficiency and uniformity of the light irradiating the image forming region S of the liquid crystal device 400R, 400G, 400B can be suppressed, making it possible to obtain a bright and uniform in-plane display characteristic on the screen SCR.

Although a detailed description has heretofore been given of the second lens array 130A of the projector 1000 of embodiment 1, the projector 1000 of embodiment 1 also has the following characteristics

In the projector 1000 of embodiment 1, as shown In FIGS. 1A to 1B, the plurality of first small lenses 122A are decentered in such a way that the light from the light source device 110A becomes a divergent light having the illumination optical axis 100Aax as its central axis, while the plurality of second small lenses 132A are decentered in such a way that the principal ray of the individual partial light fluxes from the first lens array 120A becomes a light substantially parallel to the illumination optical axis 100Aax. Therefore, it is possible to increase a proportion of the light passed through the first lens array 120A incident on each second small lens 132A, making it possible to improve a projector's light use efficiency.

In the projector 1000 of embodiment 1, the plurality of first small lenses 122A are decentered for each column, and the thickness of each first small lens 122A is adjusted in order to reduce unevenness in the boundary between the respective first small lenses 122A. Therefore, it is possible to suppress a deterioration in die releasing in a case of manufacturing the first lens array 120A by pressing. As a result, it is possible to manufacture a lens array of a shape desirable for the first lens array.

Also, according to the projector of embodiment 1, the plurality of second small lenses 132A are decentered for each column. Therefore, it is possible to reduce an unevenness on the whole surface of the first lens array 120A, thus making it possible to manufacture a lens array of a shape desirable for the first lens array.

According to the projector 1000 of embodiment 1, the first lens array 120A and the second lens array 130A are separate from each other, and can therefore be press molded as separate members. For this reason, it is easy to manufacture the first lens array and the second lens array.

### Embodiment 2

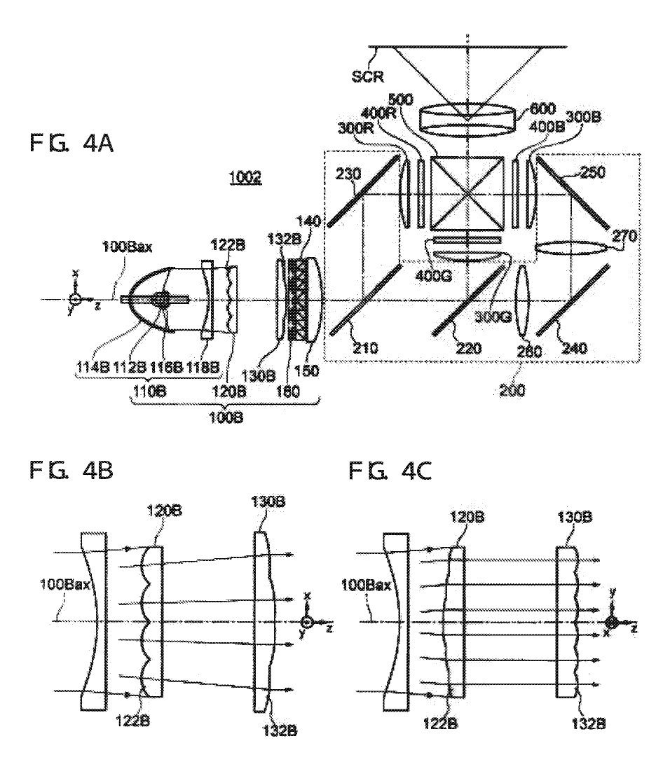

FIGS. 4A to 4C are views shown for illustrating a projector 1002 according to embodiment 2. FIG. 4A is a view showing an optical system of the projector 1002, FIG. 4B is a top view of a main portion of the projector 1002, and FIG. 4C is a side view of the main portion of the projector 1002.

In FIGS. 4A to 4C, members identical to those in FIGS. 1A to 1C are given identical reference numerals, and the detailed description will be omitted.

Although the projector 1002 of embodiment 2 basically has a configuration similar to that of the projector 1000 of embodiment 1, as shown in FIGS. 4A to 4C, a light source device, a first lens array and a second lens array of the projector 1002 are different in configuration from those of the projector 1000 of embodiment 1.

That is, in the projector 1000 of embodiment 1, as shown in FIGS. 1A to 1C, the light source device 110A, which emits a light substantially parallel to the illumination optical axis 100Aax, is used as the light source device. Also, therewith, the first lens array 120A, in which some first small lenses 122A are decentered in such a way as to emit incident illumination light fluxes outward with respect to the illumination optical axis 100Aax, and in which a plurality of first small lenses 122A decentered for each column are disposed, is used as the first lens array. The second lens array 130A, in which a plurality of second small lenses 132A are disposed in the manner that they are decentered in such a way as to emit incident illumination light fluxes by making them substantially parallel to the illumination optical axis 100Aax, and decentered for each column, is used as the second lens array.

In contrast, in the projector 1002 of embodiment 2, as shown in FIGS. 4A to 4C, a light source device 110B, which emits a divergent light having an illumination optical axis 100Bax as its central axis, is used as the light source device. Also, therewith, a first lens array 120B, in which a plurality of first small lenses 1225 are disposed in the manner that they are decentered in such a way as to emit incident illumination light fluxes by making them substantially parallel to the illumination optical axis 100Bax, and decentered for each row, is used as the first lens array. A second lens array 130B, in which a plurality of second small lenses 1323 are disposed in the manner that they are decentered in such a way as to emit incident illumination light fluxes substantially parallel to the illumination optical axis 100Bax, and decentered for each column, is used as the second lens array.

The light source device 110B includes a paraboloidal reflector 114B, a luminous tube 112B having a luminescent center in the vicinity of the focal point of the paraboloidal reflector 114B, an auxiliary mirror 116B acting as a reflector which, being provided on the luminous tube 112B, reflects a light emitted from the luminous tube 112B to an illuminated region side, toward the paraboloidal reflector 114B, and a concave lens 1181B which converts the light reflected off the paraboloidal reflector 114B into a divergent light having the illumination optical axis 100Bax as its central axis. The light source device 110B emits a luminous flux having the illumination optical axis 100Bax as its central axis.

The luminous tube 112B includes a tube portion and a pair of sealing portions extending to both sides of the tube portion.

The paraboloidal reflector 114B includes a tubular neck-like portion, which is inserted through and fixed to one of the sealing portions of the luminous tube 112B, and a reflecting concave surface which reflects the light emitted from the luminous tube 112B, toward the illuminated region side.

The auxiliary mirror 116B, being provided across the tube portion of the luminous tube 112B from the paraboloidal reflector 114B, causes the light emitted from the luminous tube 112B, which is not directed to the paraboloidal reflector 114B, to return to the luminous tube 112B and enter the paraboloidal reflector 114B.

The concave lens 118B, disposed on the illuminated region side of the paraboloidal reflector 114B, is configured in such a way as to convert the light from the paraboloidal reflector 114B into the divergent light having the illumination optical axis 100Bax as its central axis and emit the converted light toward the first lens array 120B.

The first lens array 120B, having a function of serving as a luminous flux division optical element which divides the light from the concave lens 118B into a plurality of partial light fluxes, is configured to include the plurality of first small lenses 122B which are arrayed in a matrix in a plane perpendicular to the illumination optical axis 100Bax. Although an illustrative description is omitted, the outer shape of the first small lenses 122B is similar to that of an image forming region S of liquid crystal device 400R, 400G, 400B.

The individual first small lenses 122B of the first lens array 120B are decentered in such a way as to emit -he incident illumination light fluxes by making them substantially parallel to the illumination optical axis 100Bax, and decentered for each row.

The second lens array 130B, which is an optical element which collects the plurality of partial light fluxes divided by the first lens array 120B, is configured, similarly to the first lens array 120B, to include the plurality of second small lenses 132B which are arrayed in a matrix in a plane perpendicular to the illumination optical axis 100Bax.

As shown in FIG. 4B, the second lens array 130B has a structure in which the thickness of each second small lens 132B is adjusted in order to reduce unevenness n the boundary between the respective second small lenses 132B.

As shown in FIGS. 4B and 4C, the individual second small lenses 132B of the second lens array 130B are decentered in such a way as to emit the incident illumination light fluxes by making them substantially parallel to the illumination optical axis 100Bax, and decentered for each column, as well as being decentered in such a way that the individual partial light fluxes from the second lens array 130B are made incident on a light transmissive portion 164 of a light shielding member 160.

The curvature of the individual second small lenses 132B is set individually for each small lens, in such a way that images of the corresponding small lenses 122B are formed in the same location in the vicinity of the image forming region S of the liquid crystal device 400R, 400G, 400B.

As shown in FIGS. 4B and 4C, the distances between the convex vertices of the corresponding first and second small lenses 122B, 132B are different depending on the respective first and second small lenses.

Although the light source device, first lens array and second lens array of the projector 1002 of embodiment 2 are thus different in configuration from those of the projector 1000 of embodiment 1, as with the projector 1000 of embodiment 1, the thickness of each second small lens 132B is adjusted in order to reduce an evenness in the boundary between the respective second small lenses 132B. Therefore, it is possible to suppress a deterioration in die releasing in a case of manufacturing the second lens array 130B by pressing. As a result, it is possible to manufacture a lens array of a shape desirable for the second lens array.

Also, according to the projector 1002 of embodiment 2, as the plurality of second small lenses 132B are decentered for each column, it is possible to reduce an unevenness on the whole surface of the second lens array 130B, thus making it possible to manufacture a lens array of a shape desirable for the second lens array.

Furthermore, according to the projector 1002 of embodiment 2, the curvature of the individual second small lenses 132B is set in such a way that the images of the corresponding small lenses 122A are formed in the same location in the vicinity of the image forming region S of the liquid crystal device 400R, 400G, 400B. Therefore, even in a case of using the second lens array 130B in which, as described heretofore, the distances between the convex vertices of the corresponding first and second small lenses 122B, 132B are different depending on the respective first and second small lenses, furthermore, the plurality of second small lenses 132B are decentered for each column, and the thickness of each second small lens 132B is adjusted in order to reduce an unevenness in the boundary between the respective second small lenses 132B, it is possible to make the images of the first small lenses 122A substantially identical in image location and magnification for each of the individual partial light fluxes emitted from the plurality of second small lenses 132B of the second lens array 130B. As a result, a reduction in use efficiency and uniformity of a light irradiating the image forming region S of the liquid crystal device 400R, 400B, 400B can be suppressed, making it possible to obtain a bright and uniform in-plane display characteristic on the screen SCR.

Consequently, similar to the projector 1000 of embodiment 1, the projector 1002 of embodiment 2 provides a projector for which it is possible to manufacture a lens array of a shape desirable for the second lens array. Also, it provides a projector capable of obtaining a bright and uniform in-plane display characteristic on the screen SCR.

Also, in the projector 1002 of embodiment 2, the plurality of second small lenses 132B are decentered in such a way that the principal ray of the individual partial light fluxes from the first lens array 1203B becomes a light substantially parallel to the illumination optical axis 100Bax. Therefore, there is also an advantageous effect that it is possible to increase a proportion of the light passed through the first lens array 120B incident on each second small lens 132B, making it possible to improve a projector's light use efficiency.

The projector 1002 of embodiment 2 has the same configuration as the projector 1000 of embodiment 1 with the exception of the configuration of the light source device, first lens array and second lens array, and therefore has the same advantageous effects as with the projector 1000 of embodiment 1.

### Embodiment 3

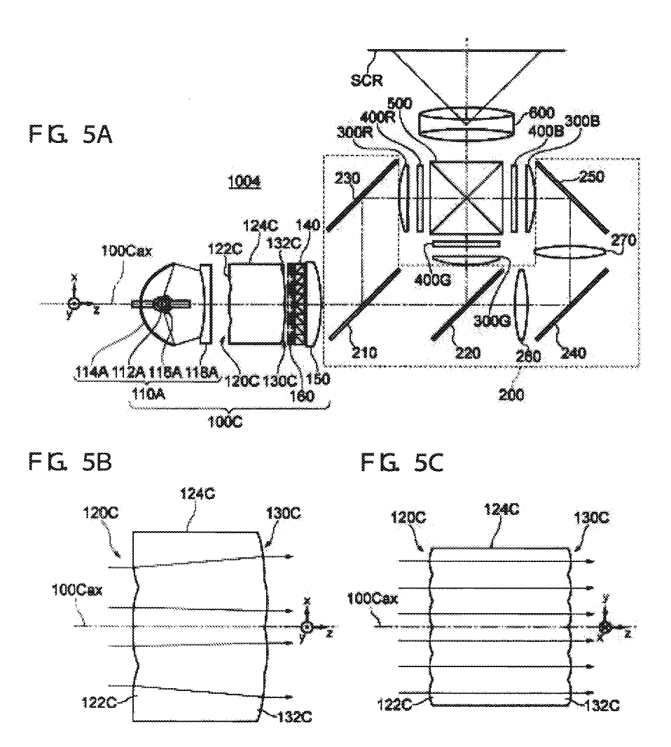

FIGS. 5A to 5C are views shown for illustrating a projector 1004 according to embodiment 3. FIG. 5A is a view showing an optical system of the projector 1004, FIG. 53 is a top view of a main portion of the projector 1004, and FIG. 5C is a side view of the main portion of the projector 1004.

In FIGS. 5A to 5C, members identical to those in FIGS. 1A to 1C are given identical reference numerals, and the detailed description will be omitted.

Although the projector 1004 of embodiment 3 basically has a configuration similar to that of the projector 1000 of embodiment 1, as shown in FIGS. 5A to 5C, a first lens array and a second lens array of the projector 1004 are different in configuration from those of the projector 1000 of embodiment 1. That is, as shown in FIGS. 5A to 5C the projector 1004 of embodiment 3 uses a lens array unit 124C in which a first lens array 120C and a second lens array 130C are integrally molded.

For this reason, according to the projector 1004 of embodiment 3, illumination light fluxes emitted from the first lens array 120C are made incident on the second lens array 130C without passing through any air space, thus preventing an occurrence of light reflection off a first lens array light emergence surface and a second lens array light incidence surface and so on. For this reason, it is possible to suppress a light quantity loss due to such an undesirable reflection etc. Also, to assemble the apparatus, there is no need to align the first lens array and the second lens array, and it is possible to suppress a deterioration in position accuracy of the first lens array and the second lens array after assembling the apparatus.

### Embodiment 4

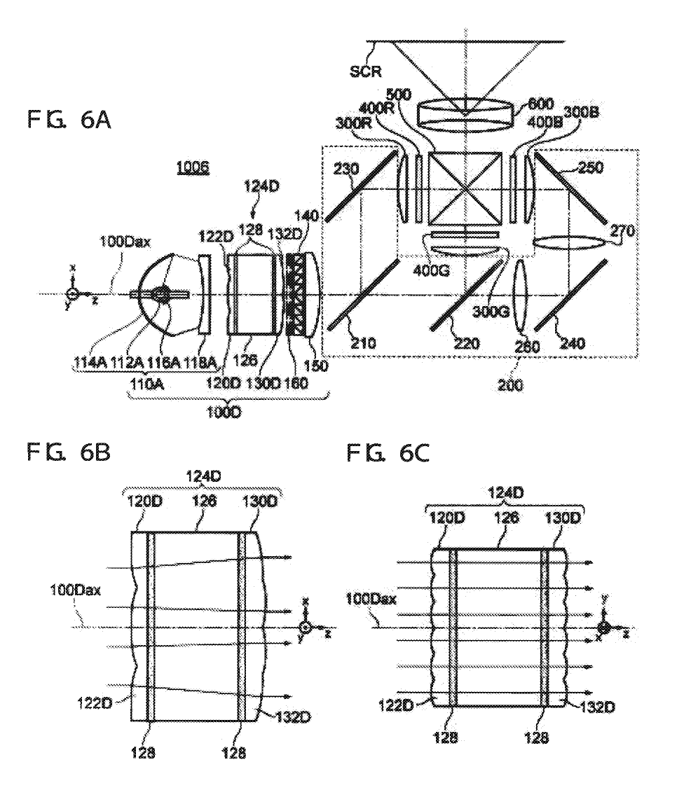

FIGS. 6A to 6C are views shown for illustrating a projector 1006 according to embodiment 4. FIG. 6A is a view showing an optical system of the projector 1006, FIG. 6B is a top view of a main portion of the projector 1006, and FIG. 6C is a side view of the main portion of the projector 1006.

In FIGS. 6A to 6C, members identical to those in FIGS. 1A to 1C are given identical reference numerals, and the detailed description will be omitted.

Although the projector 1006 of embodiment 4 basically has a configuration similar to that of the projector 1000 of embodiment 1, as shown in FIGS. 6A to 6C, a first lens array and a second lens array of the projector 1006 are different in configuration from those of the projector 1000 of embodiment 1. That is, as shown in FIGS. 6A to 6C, the projector 1006 of embodiment 4 uses a lens array unit 124D which includes, between a first lens array 1201D and a second lens array 130D, a light transmissive member 126 for leading a light from the first lens array 120D to the second lens array 130D, and in which the first lens array 1201D and the second lens array 130D are bonded via the light transmissive member 126.

The light transmissive member 126 is made of the same base material as that of the first lens array 120D and the second lens array 130D1. For example, sapphire, crystal, silica glass, hard glass, crystallized glass, plastics, etc. are suitably used as the material of the that transmissive member 126.

Also, an adhesive 128 for bonding the first lens array 120D, the light transmissive member 126 and the second lens array 130D has a refractive index substantially equal to that of the first lens array 120D and the second lens array 130D.

As described heretofore, the projector 1006 of embodiment 4 uses the lens array unit 124D which includes, between the first lens array 120D and the second lens array 130D, the light transmissive member 126 for leading the light from the first lens array 120D to the second lens array 130D, and in which the first lens array 120D and the second lens array 130D are bonded via the light transmissive member 126. For this reason, illumination light fluxes emitted from the first lens array 120D are made incident on the second lens array 130D without passing through any air space, thus making it possible to suppress light reflection off the light emergence surface of the first lens array 120D and the light incidence surface of the second lens array 130D and so on. For this reason, it is possible to reduce a light quantity loss due to such undesirable reflection etc. Also, to assemble the apparatus, the first lens array 120D and the second lens array 130D are aligned and thereafter bonded in advance to the light transmissive member 126, whereby it is only necessary to adjust the relative positions of the lens array unit 124D, configured of these first lens array 120D, second lens array 130D and light transmissive member 126, and the other optical elements, so that an alignment of each optical element can be easily carried out.

Although the projector of aspects of the invention has heretofore been described with reference to each aforementioned embodiment, the invention is not limited to each aforementioned embodiment, but can be practiced in various forms without departing from its scope and, for example, the following modifications are also possible.

(1) Although the aforementioned projectors 1000 to 1006 of aspects of the invention are a so-called 3-LCD projector equipped with three liquid crystal devices as electro-optic modulators, the invention is not limited thereto, and can also be applied to a projector equipped with one, two or four or more liquid crystal devices.

(2) Although the aforementioned projectors 1000 to 1006 are a transmissive type projector, the invention is not limited thereto. The invention can be applied to a reflective type projector. As used herein, the “transmissive type” refers to a type in which an electro-optic modulator acting as a light modulator transmits light like a transmissive electro-optic modulator etc., while the “reflective type” refers to a type in which an electro-optic modulator acting as a light modulator reflects light like a reflective electro-optic modulator. Even in a case that the invention is applied to the reflective type projector, it is possible to obtain the same advantageous effects as in the transmissive type projector.

(3) In the aforementioned projectors 1000 to 1006, a liquid crystal device using a liquid crystal panel is used as an electro-optic modulator, but the invention is not limited thereto. As the electro-optic modulator, in general, any type will suffice which modulates an incident light in accordance with image information, and it is also acceptable to use a micromirror light modulator etc. For example, a DMD (Digital micromirror Device) (a trademark of Texas Instruments, Inc.) can be used as the micromirror light modulator.

(4) In addition, it is needless to say that the invention can be applied to both a front projector, which projects a projection image from an observer's side, and a rear projector, which projects a projection image from a side opposite the observer's side.

Further, while this invention has been described in conjunction with the specific embodiments thereof, it is evident that many alternatives, modifications and variations will be apparent to those skilled in the art. Accordingly, preferred embodiments of the invention as set forth herein are intended to be illustrative, not limiting. There are changes that may be made without departing from the spirit and scope of the invention.

The priority applications Numbers JP2005-302789 upon which this patent application is based is hereby incorporated by reference.

What is claimed is:

1. A projector comprising:
an illumination device having a light source device that emits an illumination light flux to an illuminated region side, a first lens array having a plurality of first small lenses that divide the illumination light flux emitted from the light source device into a plurality of partial light fluxes, a second lens array having a plurality of second small lenses corresponding to the plurality of first small lenses, and a superimposing lens that superimposes the partial light fluxes emitted from the plurality of second small lenses, one on another, in an illuminated region;
an electricoptic modulator that modulates the illumination light fluxes from the illumination device in accordance with image information; and
a projection optical system that projects the light modulated by the electro-optic modulator,
the plurality of first small lenses being arrayed in a matrix in a plane perpendicular to an illumination optical axis,
the plurality of second small lenses being arrayed in a matrix in a plane perpendicular to the illumination optical axis and being decentered for each row or for each column,
a thickness of the individual second small lenses being adjusted in order to reduce an unevenness in a boundary between each second small lens, and
a curvature of the individual second small lenses being set in such a way that images of the corresponding first small lenses are formed in the same location in the vicinity of an image forming region of the electro-optic modulator.

2. A projector according to claim 1,
the curvature of the individual second small lenses being set individually for each small lens.

3. A projector according to claim 1,
the curvature of the individual second small lenses being set in such a way that the second small lenses disposed on the central side of the second lens array are larger in curvature radius than the second small lenses disposed on the outer peripheral side of the second lens array.

4. A projector according to claim 1, further comprising:
a polarization conversion element provided between the second lens array and the superimposing lens and having a polarization separating layer, a reflecting layer and a phase plate; and
a light shielding member disposed on the light incidence surface side of the polarization conversion element,
the polarization separating layer transmitting illumination light fluxes related to one linear polarization component of polarization directions included in the individual partial light fluxes from the second lens array, and reflecting illumination light fluxes related to the other linear polarization component,
the reflecting layer reflecting the illumination light fluxes related to the other linear polarization component, reflected off the polarization separating layer, in a direction substantially parallel to the illumination optical axis,
the phase plate disposed either in a portion through which the illumination light fluxes related to the one linear polarization component pass, transmitted through the polarization separating layer, or in a portion through which the illumination fluxes related to the other linear polarization component pass, reflected off the reflecting layer,
the light shielding member having a light shielding portion disposed in a position corresponding to the reflecting layer and a light transmissive portion disposed in a position corresponding to the polarization separating layer, and
the plurality of second small lenses being decentered in such a way that the individual luminous fluxes from the first lens array are made incident on the light transmissive portion.

5. A projector according to claim 1,
the light source device emitting a divergent light having the illumination optical axis as its central axis, and
the plurality of second small lenses being decentered in such a way that a principal ray of each partial light flux becomes substantially parallel to the illumination optical axis.

6. A projector according to claim 1,
the light source device emitting a light substantially parallel to the illumination optical axis,
the plurality of first small lenses being decentered in such a way that the light from the light source device becomes a divergent light having the illumination optical axis as its central axis, and
the plurality of second small lenses being decentered in such a way that the principal ray of each partial light flux from the first lens array becomes a light substantially parallel to the illumination optical axis.

7. A projector according to claim 6,
the plurality of first small lenses being decentered for each row or for each column, and
the thickness of each first small lens being adjusted in order to reduce an unevenness in the boundary between the respective first small lenses.

8. A projector according to claim 1,
the first lens array and the second lens array being integrally molded.

9. A projector according to claim 1,
the first lens array and the second lens array being separate from each other.

10. A projector according to claim 9, further comprising
a light transmissive member that is disposed between the first lens array and the second lens array and guides the light from the first lens array to the second lens array,
the first lens array and the second lens array being bonded via the light transmissive member.
